(19) United States
(12) Patent Application Publication
(10) Pub. No.: US 2026/0180476 A1
(43) Pub. Date: Jun. 25, 2026

(54) MOTOR SYSTEM AND CONTROL METHOD THEREOF

(71) Applicant: INDUSTRIAL TECHNOLOGY RESEARCH INSTITUTE, Hsinchu (TW)

(72) Inventors: Jia-Yao JHANG, Taoyuan City (TW); Chia-Min TING, Taoyuan City (TW); Chun-Chieh CHANG, Taipei City (TW); Cheng-Min CHANG, Keelung City (TW)

(73) Assignee: INDUSTRIAL TECHNOLOGY RESEARCH INSTITUTE, Hsinchu (TW)

(21) Appl. No.: 19/186,171

(22) Filed: Apr. 22, 2025

(30) Foreign Application Priority Data
Dec. 19, 2024 (TW) 113149658

(51) Int. Cl. H02P 6/15

(52) U.S. Cl. CPC H02P 6/153

(57) ABSTRACT

A motor system and a motor control method are disclosed in the application. The motor control method comprises: generating a DC bus voltage and an output current based on an input voltage from the power supply; generating a feedback voltage value corresponding to the DC bus voltage and a plurality of feedback current values corresponding to the output current, wherein the output current includes a first-phase current, a second-phase current, and a third-phase current; rotating a motor by the output current, and generating a position signal associated with a rotational speed of the motor; generating a modulation signal and a pulse width modulation (PWM) signal based on the feedback voltage value, the feedback current values, and the position signal; and adjusting the first-phase current, the second-phase current, the third-phase current, and the DC bus voltage in response to the modulation signal and the PWM signal.

This application claims the benefit of Taiwan application Serial No. 113149658, filed Dec. 19, 2024, the disclosure of which is incorporated by reference herein in its entirety.

### TECHNICAL FIELD

This disclosure relates to a motor system, particularly to a motor system with adjustable frequency and its control method.

### BACKGROUND

High-speed servo motors have been widely applied in various aspects of daily life, such as automotive power systems, high-precision grinding machines, cutting tools, unmanned aerial vehicle (UAV) power systems, and more. To meet the demand for high-speed motor rotation, in motor drive and control, the drive current must reach a sufficient frequency (i.e., speed control frequency), and the power transistors of the power module must be controlled at an appropriate switching speed (i.e., the pulse width modulation (PWM) frequency of the PWM signal).

Moreover, when the motor operates over a wide speed range, conventional motor drivers often face the following technical issues: (1) difficulty in achieving stable drive at high speeds and (2) significant increase in power loss at low speeds.

Additionally, when the sampling frequency of the PWM signal is much higher than the PWM frequency of the PWM signal, there is a need to wait for the PWM signal to update after the sampling calculation is completed. This may lead to delays in transmitting certain system signals, thereby affecting the overall normal operation of the system.

In response to the aforementioned issues, an improved motor system is needed, capable of dynamically adjusting the drive current frequency and the switching speed of the power transistors to adapt to different motor speeds.

### SUMMARY

According to one embodiment, a motor system is provided. The motor system is suitable for connection to a power supply and a motor, the motor is rotating when driven by an output current and generating a position signal associated with a rotational speed of the motor. The motor system comprises: a motor driver, further comprising: a power module and a control module. The power module generates a DC bus voltage and the output current based on an input voltage from the power supply, and produces a feedback voltage value corresponding to the DC bus voltage and a plurality of feedback current values corresponding to the output current, wherein the output current includes a first-phase current, a second-phase current, and a third-phase current. The control module, coupled to the power module, generates a modulation signal and a pulse width modulation (PWM) signal based on the feedback voltage value, the feedback current values, and the position signal. The power module adjusts the first-phase current, the second-phase current, the third-phase current, and the DC bus voltage in response to the modulation signal and the PWM signal.

According to another embodiment, a motor control method is provided. The motor control method is executed by a motor system. The motor control method comprises: generating by a power module of a motor driver a DC bus voltage and an output current based on an input voltage from the power supply; generating by the power module a feedback voltage value corresponding to the DC bus voltage and a plurality of feedback current values corresponding to the output current, wherein the output current includes a first-phase current, a second-phase current, and a third-phase current; rotating a motor by the output current, and generating a position signal associated with a rotational speed of the motor; generating, by a control module of the motor driver, a modulation signal and a pulse width modulation (PWM) signal based on the feedback voltage value, the feedback current values, and the position signal; and adjusting, by the power module, the first-phase current, the second-phase current, the third-phase current, and the DC bus voltage in response to the modulation signal and the PWM signal.

### BRIEF DESCRIPTION OF THE DRAWINGS

FIG. 1 is a block diagram of a motor system according to an embodiment of this disclosure.

FIG. 2A is a block diagram of the power module from FIG. 1.

FIG. 2B is a block diagram of the control module from FIG. 1.

FIG. 3A is waveform diagrams of PWM signal.

FIG. 3B illustrates the waveforms of the triangular wave signal, the first phase current, the second phase current, and the third phase current.

FIG. 4 is a flowchart of a motor control method according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

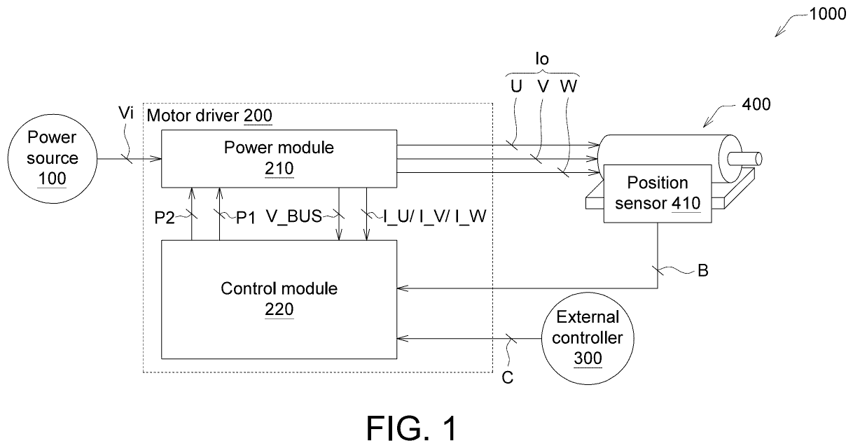

Please refer to FIG. 1, which is a block diagram of a motor system 1000 according to an embodiment of this disclosure. The motor system 1000 is suitable for connecting an external power source 100 to an electric motor 400 and includes a motor driver 200, where the motor driver 200 comprises a power module 210 and a control module 220. Additionally, the motor 400 includes a position sensor 410. In another embodiment, the disclosed motor system 1000 may include only the motor driver 200 and the motor 400 as an example.

During operation, the power source 100 supplies an input voltage Vi to the power module 210 of the motor driver 200. In response to the input voltage Vi, the power module 210 generates a DC bus voltage Vo and an output current Io. The output current Io is in the form of a three-phase current, including: first-phase current U, second-phase current V, and third-phase current W. These currents U, V, and W are supplied to the motor 400, thereby driving its rotation.

The power module 210 can further analyze the feedback current values I_U, I_V, and I_W, corresponding to the first-phase current U, second-phase current V, and third-phase current W, respectively. The power module 210 also analyzes the feedback voltage value V_BUS, corresponding to the DC bus voltage Vo. The power module 210 then transmits the feedback current values I_U, I_V, and I_W, as well as the feedback voltage value V_BUS, to the control module 220.

The motor 400 rotates in response to driving by the phase currents U, V, and W. Additionally, the position sensor 410 detects the rotation mechanism of the motor 400 (not shown in FIG. 1) and generates a position signal B. The position sensor 410 then transmits the position signal B to the control module 220.

The motor system 1000 can also operate in coordination with an external controller 300. The external controller 300 may be a personal computer, a smartphone, or a mobile device. The external controller 300 includes a user interface, allowing the user to issue commands to control the motor system 1000 through the external controller 300. The external controller 300 converts the user's commands into a control signal C and transmits the control signal C to the control module 220.

The control module 220 receives the feedback current values I_U, I_V, and I_W, and the feedback voltage value V_BUS from the power module 210, the position signal B from the position sensor 410, and the control signal C from the external controller 300. Based on the feedback current values I_U, I_V, and I_W, the feedback voltage value V_BUS, the position signal B, and the control signal C, the control module 220 generates a corresponding modulation signal P2 and a pulse-width modulation (PWM) signal P1. The modulation signal P2, also referred to as the “DC bus modulation signal,” is used to modulate the DC bus voltage. The control module 220 then transmits both the modulation signal P2 and the PWM signal P1 to the power module 210, enabling the power module 210 to adjust the first-phase current U, second-phase current V, and third-phase current W accordingly.

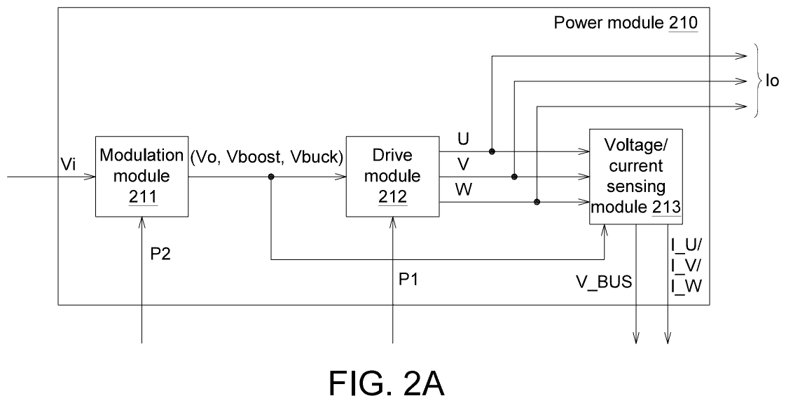

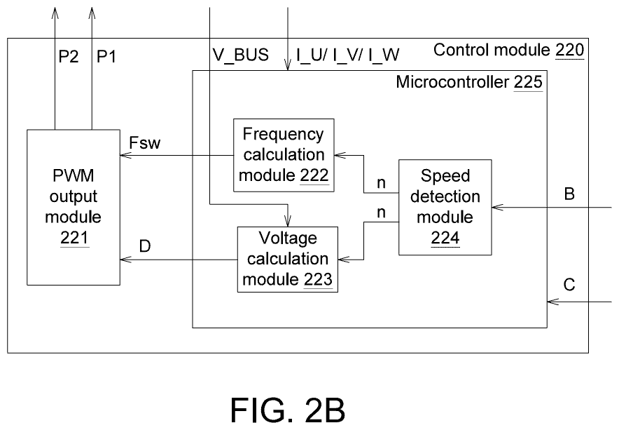

Please refer to FIG. 2A, which is a block diagram of the power module 210 from FIG. 1. The power module 210 includes a modulation module 211, a drive module 212, and a voltage/current sensing module 213. The modulation module 211, also known as the “DC bus modulation module,” is for modulating the DC bus voltage. The modulation module 211 may include a boost circuit and a buck circuit (not shown in FIG. 1). The modulation module 211 receives the input voltage Vi and the modulation signal P2. In response to P2, the modulation module 211 converts the input voltage Vi into the DC bus voltage Vo.

The drive module 212 receives the DC voltage Vo and the PWM signal P1. Under the control of the PWM signal P1, the drive module 212 converts the DC bus voltage Vo to generate the first-phase current U, second-phase current V, and third-phase current W.

The voltage/current sensing module 213 measures the first-phase current U, second-phase current V, and third-phase current W, generating the respective feedback current values I_U, I_V, and I_W. Additionally, the voltage/current sensing module 213 senses the DC bus voltage Vo to generate the corresponding feedback voltage value V_BUS. The voltage/current sensing module 213 then outputs the feedback current values I_U, I_V, and I_W, along with the feedback voltage value V_BUS.

Please refer to FIG. 2B, which is a block diagram of the control module 220 from FIG. 1. The control module 220 may be a control circuit board of the motor driver 200. The control module 220 includes a pulse-width modulation (PWM) output module 221, a frequency calculation module 222, a voltage calculation module 223, and a speed detection module 224. In one example, the control module 220 includes a microcontroller 225, where the frequency calculation module 222, voltage calculation module 223, and speed detection module 224 are submodules within the microcontroller 225. During operation, the speed detection module 224 receives the position signal B detected by the position sensor 410 and, based on B, determines the current rotational speed n of the motor 400. Furthermore, the speed detection module 224 detects whether the rotational speed n has changed. The detected rotational speed n is then provided to both the frequency calculation module 222 and the voltage calculation module 223.

The frequency calculation module 222 calculates the required frequency f of the output current Io for the motor 400 based on the rotational speed n. The frequency f of the output current Io corresponds to the frequency of the first-phase current U, second-phase current V, and third-phase current W. Furthermore, based on the frequency f, the frequency calculation module 222 determines the PWM frequency Fsw. More specifically, the frequency calculation module 222 can calculate the output current frequency f and the PWM frequency Fsw using Equation (1-1) and Equation (1-2). Equation (1-1) represents the relationship between the rotational speed n and the frequency f:

$$n = ( 120 / p ) * f \qquad ( 1 ‐ 1 )$$

In Equation (1-1), besides the rotational speed n and frequency f, there is an additional parameter “p”, which represents the number of poles in the motor 400. For example, if motor 400 is a four-pole servo motor, then the number of poles p equals 4. If the desired rotational speed n of motor 400 is 45,000 rpm, the frequency calculation module 222 calculates the frequency f of the output current Io of the motor 400 using Equation (1-1), resulting in 1.5 KHz.

Additionally, Equation (1-2) represents the relationship between frequency f and the PWM frequency Fsw:

$$Fsw = 10 \times f \qquad ( 1 ‐ 2 )$$

In Equation (1-2), the PWM frequency Fsw is a multiple of the output current Io frequency f (e.g., 10 times). When motor 400 requires an output current Io having a frequency f of 1.5 kHz, the corresponding PWM frequency Fsw is 15 KHz.

The voltage calculation module 223 receives the feedback voltage value V_BUS, which represents the value of the DC bus voltage Vo. Thus, the voltage calculation module 223 can derive the DC bus voltage Vo from V_BUS and use to calculate the modulation duty cycle D. More specifically, the modulation duty cycle D, also known as the “duty ratio,” is used to set the modulation signal P2, which controls the modulation module 211 to achieve an appropriate DC bus voltage Vo. When motor 400 operates at a predetermined speed (e.g., rated speed), the DC bus voltage Vo may be counteracted by the back electromotive force (EMF) of the motor rotor's stator windings. Therefore, if an increase in rotational speed n of motor 400 is required, the DC bus voltage Vo must be further increased. If the rotational speed n of motor 400 reaches a limit, a slight increase in DC bus voltage (e.g., 10% increase) can enable further rotational speed increments. In other words, when the motor 400 speed n exceeds the rated rotational speed, the DC bus voltage should be increased—i.e., boosting. The relationship between the boosted voltage Vboost and the original DC bus voltage Vo is expressed in Equation (1-3):

$$Vboost / Vo = 1 / ( 1 - D ) \qquad ( 1 ‐ 3 )$$

If the modulation duty cycle D is set to 10% (0.1), the relationship between Vo and the boosted voltage Vboost based on Equation (1-3) results in Equation (1-4). A 10% duty cycle increase leads to an 11% increase in the DC bus voltage:

$$Vboost = 1.11 \times Vo \qquad ( 1 ‐ 4 )$$

On the other hand, when the DC bus voltage is at the rated voltage of motor 400, and the motor 400 operates at low speed, the potential back EMF generated may only be 10% of the rated voltage, leaving only 10% of the rated voltage usable for the motor driver 200. Under this condition, large voltage ripples may occur, leading to higher energy losses. To mitigate this, reducing the DC bus voltage is recommended for reducing loss. In other words, when the rotational speed n of the motor 400 is below the predetermined speed, the DC bus voltage should be reduced—i.e., buck conversion. The relationship between the reduced DC bus voltage Vo and the bucked voltage Vbuck is expressed in Equation (1-5):

$$Vbuck / Vo = D \qquad ( 1 ‐ 5 )$$

If the modulation duty cycle D is set to 90% (0.9), then based on Equation (1-5), the relationship between Vo and the reduced voltage Vbuck is expressed in Equation (1-6). A 90% duty cycle reduces the DC bus voltage by 10%:

$$Vbuck = 0.9 \times Vo \qquad ( 1 ‐ 6 )$$

Alternatively, if the modulation duty cycle D is set to 50%, the DC bus voltage is reduced by 50%, as shown in Equation (1-7):

$$Vbuck = 0.5 \times Vo \qquad ( 1 ‐ 7 )$$

The PWM output module 221 receives the PWM frequency Fsw calculated by the frequency calculation module 222 and the modulation duty cycle D calculated by the voltage calculation module 223. The PWM output module 221 then generates the corresponding PWM signal P1 based on the PWM frequency Fsw, ensuring that the PWM signal P1 has the appropriate PWM frequency Fsw. The PWM output module 221 provides the PWM signal P1 to the drive module 212. Additionally, the PWM output module 221 generates the modulation signal P2 based on the duty cycle D and sends the modulation signal P2 to the modulation module 211.

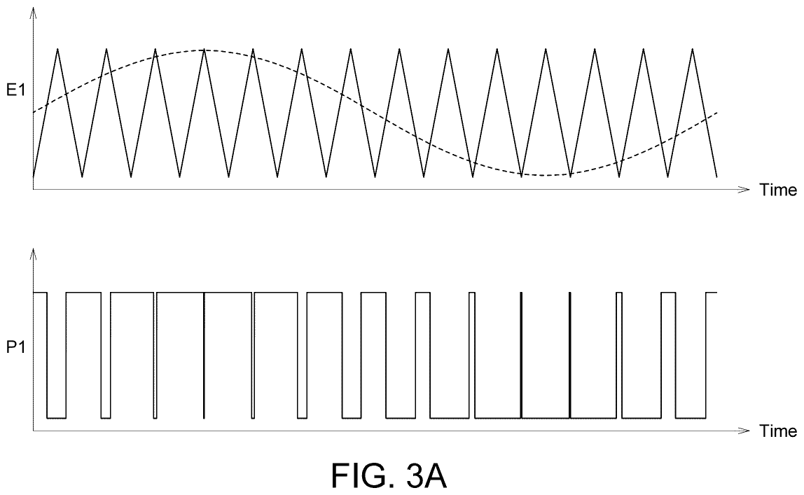

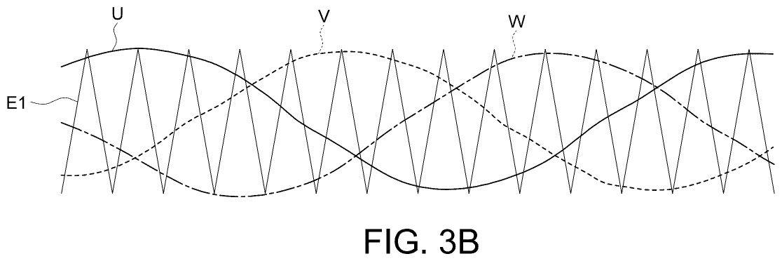

Specifically, the PWM signal P1 is used to control the power switches inside the drive module 212. The switching speed of the power switches is determined based on the PWM frequency Fsw of the PWM signal P1. Please refer to the waveform diagram of PWM signal P1 in FIG. 3A. In the example shown in FIG. 3A, PWM signal P1 can be generated based on the triangular wave signal E1, where the frequency of the triangular wave signal E1 is equal to the PWM frequency Fsw. When the PWM frequency Fsw is higher, the output current Io generated by the drive module 212 can be more finely divided, allowing motor 400 to operate stably at high rotational speeds.

Next, refer to FIG. 3B, which illustrates the waveforms of the triangular wave signal E1, the first phase current U, the second phase current V, and the third phase current W. When the PWM frequency Fsw of PWM signal P1 is higher, the corresponding triangular wave signal E1 has a higher frequency. A higher-frequency triangular wave signal E1 can more precisely divide the first phase current U, second phase current V, and third phase current W, ensuring that motor 400 operates stably at high speeds.

Refer again to FIG. 2B. The microcontroller 225 adjusts the sampling frequency fs of the PWM signal P1 based on the PWM frequency Fsw. In one example, the microcontroller 225 sets the sampling frequency fs according to Equation (2-1), where the sampling frequency fs has a predetermined ratio Ps to the PWM frequency Fsw. For example, when the predetermined ratio Ps is 4 and the PWM frequency Fsw is 15 kHz, the microcontroller 225 adjusts the sampling frequency fs to 60 KHz.

$$( fs / Fsw ) = ( Ps / 1 ) \qquad ( 2 ‐ 1 )$$

Moreover, the microcontroller 225 maintains the sampling frequency fs within a predetermined range, which is, for example, between a minimum sampling frequency f_min and a maximum sampling frequency f_max as shown in Equation (2-2):

$$f\_min < fs < f\_max \qquad ( 2 ‐ 2 )$$

The following describes the simulation operation and performance verification of the motor system 1000. First, the first embodiment of the simulated operation of the motor system 1000 is explained. Regarding the component selection for the simulated operation of the motor system 1000, the power stage circuit element (i.e., the power switch) of the power module 210 is selected as a single discrete insulated gate bipolar transistor (IGBT). Additionally, motor 400 is selected as a four-pole spindle motor with a rated speed of 36,000 rpm (i.e., the rated speed n of motor 400 is 36,000 rpm, and the pole number p of motor 400 is 4). The relationship between the rotational speed n of motor 400 and the frequency f of the output current Io is shown in Table 1:

TABLE 1

| Rotational speed n (rpm) | Frequency f of the output current lo (Hz) |
|---|---|
| 5000 | 166.7 |
| 10000 | 333.3 |
| 20000 | 667 |
| 30000 | 1000 |
| 40000 | 1333 |

For the performance verification of motor system 1000, when motor 400 operates at a rotational speed n of 5000 rpm, the corresponding output current Io frequency f is 166.7 Hz, and the corresponding PWM frequency is 2 kHz. Under this operating condition, the energy loss of the motor driver 200 is 7.7 W, as shown in Table 2-1. The energy loss of the motor driver 200 described here refers to the energy loss of the power switches in the power module 210 of motor driver 200.

TABLE 2-1
First Embodiment of the Simulated
Operation of Motor System 1000

| | |
|---|---|
| Rotational Speed n (rpm) | 5000 |
| Frequency f of the Output Current lo (Hz) | 166.7 |
| PWM Frequency (Hz) | 2k |
| Energy Loss of Motor Driver 200 (W) | 7.7 |

On the other hand, a comparison between the first embodiment and a comparative example was conducted. In this comparative example, a high PWM frequency (15 kHz) is required under high-speed operation conditions (where the rotational speed n is 40,000 rpm). Additionally, when operating at a low speed (n=5000 rpm) with an output current Io having a frequency f of 166.7 Hz, the energy loss is 11.8 W, which is significantly higher than the energy loss of 7.7 W for motor driver 200 in the disclosed embodiment, as shown in Table 2-2. Specifically, because the PWM frequency in the first embodiment can be significantly reduced to 2 kHz (which is much lower than the 15 kHz PWM frequency in the comparative example), the energy loss of 7.7 W in the first embodiment (i.e., the energy loss of each power component of the three-phase inverter) is lower than the energy loss of 11.8 W in the comparative example. In summary, the first embodiment can reduce energy loss by 4.1 W (approximately 34.7%).

TABLE 2-2
Comparative Example of the Motor

| | |
|---|---|
| Rotational Speed n (rpm) | 5000 |
| Frequency f of the Output Current lo (Hz) | 166.7 |
| PWM Frequency (Hz) | 15k |
| Energy Loss of Motor Driver 200 (W) | 11.8 |

Next, the second embodiment of the simulated operation of motor system 1000 is described. In this embodiment, the power switches of power module 210 are selected as an integrated IGBT power module, which, for example, includes six discrete IGBT power transistors. Similar to the first embodiment, the rated rotational speed n of motor 400 in this embodiment is 36,000 rpm, and the pole number p is 4. The performance verification results of motor system 1000 in this embodiment are shown in Table 3-1. When motor 400 operates at a rotational speed n of 5000 rpm, the corresponding output current Io has a frequency f of 166.7 Hz, and the corresponding PWM frequency is 2 kHz. Under this operating condition, the energy loss of motor driver 200 is 6.3 W.

TABLE 3-1
Second Embodiment of the Simulated
Operation of Motor System 1000

| | |
|---|---|
| Rotational Speed n (rpm) | 5000 |
| Frequency f of the Output Current lo (Hz) | 166.7 |
| PWM Frequency (Hz) | 2k |
| Energy Loss of Motor Driver 200 (W) | 6.3 |

On the other hand, a comparison between the second embodiment and another comparative example was conducted. In this comparative example, under high-speed operation conditions (n=40,000 rpm), the output current Io has a frequency f of 1333 Hz, and the PWM frequency is 15 KHz. The energy loss is 18.6 W, as shown in Table 3-2.

TABLE 3-2
Comparative Example of the Motor

| | |
|---|---|
| Rotational Speed n (rpm) | 40000 |
| Frequency f of the Output Current lo (Hz) | 1333 |
| PWM Frequency (Hz) | 15k |
| Energy Loss of Motor Driver 400 (W) | 18.6 |

Furthermore, in this comparative example, under low-speed conditions (n=5000 rpm) with an output current Io having a frequency f of 166.7 Hz, if a PWM frequency of 15 kHz is used, the energy loss is 18.6 W, as shown in Table 3-3.

TABLE 3-3
Comparative Example of the Motor

| | |
|---|---|
| Rotational Speed n (rpm) | 5000 |
| Frequency f of the Output Current lo (Hz) | 166.7 |
| PWM Frequency (Hz) | 15k |
| Energy Loss of Motor Driver 400 (W) | 18.6 |

Compared to the PWM frequency of 15 kHz in the comparative example, the PWM frequency in the second embodiment disclosed herein can be significantly reduced to 2 kHz. Due to the lower PWM frequency, the energy loss in the second embodiment is 6.3 W (i.e., the energy loss of the three-phase inverter in the power module) and is smaller than the 18.6 W energy loss in the comparative example. In other words, the second embodiment reduces energy loss by 12.3 W (approximately a 66.1% reduction).

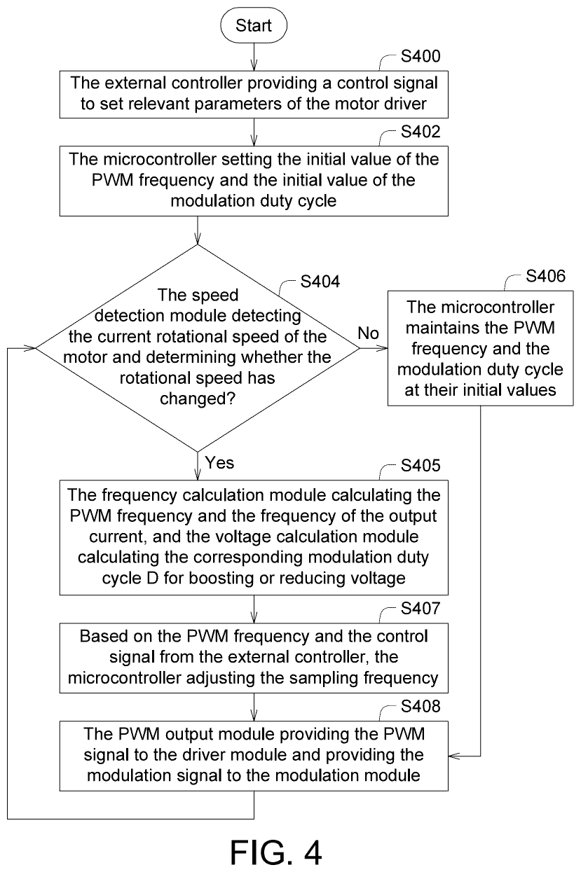

Next, please refer to FIG. 4, which is a flowchart of a motor control method according to an embodiment of the present disclosure. The motor control method of this embodiment is applied to the motor system 1000 in FIG. 1. The control or execution mechanism of the motor control method can be implemented via the power module 210 and control module 220 within the motor driver 200 of motor system 1000. First, step S400 is performed: an external controller 300 provides a control signal C to the control module 220 of the motor driver 200 to set relevant parameters of the motor driver 200.

Next, step S402 is performed: the microcontroller 225 of the motor driver 200 performs the following settings-setting the initial value of the PWM frequency Fsw of the PWM signal P1 and setting the initial value of the modulation duty cycle D of the modulation signal P2. Additionally, the modulation module 211 of the power module 210 in the motor driver 200 applies the rated DC bus voltage.

Next, step S404 is performed: the speed detection module 224 of the control module 220 detects the current rotational speed n of motor 400 based on the position signal B and determines whether the rotational speed n has changed. If the determination in step S404 is “No” (i.e., the rotational speed n of motor 400 has not changed), step S406 is performed next: the microcontroller 225 maintains the PWM frequency Fsw and the modulation duty cycle D at their initial values. Then, step S408 is performed: based on the initial PWM frequency Fsw, the microcontroller 225 adjusts the PWM signal P1, and the PWM output module 221 provides the PWM signal P1 to the driver module 212. Additionally, based on the initial modulation duty cycle D, the microcontroller 225 adjusts the modulation signal P2, and the PWM output module 221 provides the modulation signal P2 to the modulation module 211.

On the other hand, if the determination in step S404 is “Yes” (i.e., the rotational speed n of motor 400 has changed), step S405 is performed next: the frequency calculation module 222 calculates the required PWM frequency Fsw based on the current rotational speed n of motor 400. The voltage calculation module 223 then calculates the corresponding modulation duty cycle D for boosting or reducing voltage. Next, step S407 is performed: the external controller 300 generates a control signal C1, and based on the PWM frequency Fsw obtained in step S405 and the control signal C1, the microcontroller 225 adjusts the sampling frequency fs. Then, step S408 is executed: the PWM output module 221 provides the PWM signal P1 corresponding to the PWM frequency Fsw to the driver module 212 and provides the modulation signal P2 corresponding to the modulation duty cycle D to the modulation module 211. After step S408, step S404 is performed again: the speed detection module 224 detects the current rotational speed n of motor 400 and determines whether the rotational speed n has changed.

In summary, the present disclosure provides a modularly designed motor system 1000. For example, the power module 210, frequency calculation module 222, voltage calculation module 223, and speed detection module 224 are all modular designs. Furthermore, the motor system 1000 can adaptively adjust relevant frequencies (including the output current frequency f, PWM frequency Fsw, and sampling frequency fs) based on the current speed n. Additionally, it can adaptively adjust the modulation duty cycle D according to the current rotational speed n, thereby adjusting the DC bus voltage Vo of the motor system 1000. Based on the technical solutions and embodiments disclosed herein, the motor system 1000 can stably drive the motor 400 at high rotational speed and reduce the energy loss of motor driver 200 at low rotational speed. Furthermore, the PWM signal associated with motor 400 has an appropriate sampling frequency fs, ensuring real-time transmission of various system signals in motor system 1000, thereby maintaining normal operation.

While the present disclosure has been described in detail with preferred embodiments and examples, it should be understood that these examples are intended for illustrative rather than limiting purposes. It is foreseeable that various modifications and combinations may be conceived by those skilled in the art, and such modifications and combinations fall within the spirit of this disclosure and the scope of the appended claims.

What is claimed is:

1. A motor system, suitable for connection to a power supply and a motor, the motor rotating when driven by an output current and generating a position signal associated with a rotational speed of the motor, the motor system comprising:
a motor driver, further comprising: a power module and a control module,
wherein
the power module generates a DC bus voltage and the output current based on an input voltage from the power supply, and produces a feedback voltage value corresponding to the DC bus voltage and a plurality of feedback current values corresponding to the output current, wherein the output current includes a first-phase current, a second-phase current, and a third-phase current; and
the control module, coupled to the power module, generating a modulation signal and a pulse width modulation (PWM) signal based on the feedback voltage value, the feedback current values, and the position signal,
the power module adjusts the first-phase current, the second-phase current, the third-phase current, and the DC bus voltage in response to the modulation signal and the PWM signal.

2. The motor system according to claim 1, wherein the motor comprises:
a position sensor detecting a rotational mechanism of the motor to generate the position signal.

3. The motor system according to claim 1, wherein the control module comprises:
a speed detection module detecting the rotational speed of the motor based on the position signal and determining whether the rotational speed has changed.

4. The motor system according to claim 1, wherein the control module comprises:
a frequency calculation module calculating the frequency of the output current based on the rotational speed of the motor,
wherein the rotational speed is proportional to the frequency of the output current and inversely proportional to a pole number of the motor.

5. The motor system according to claim 4, wherein the frequency calculation module further calculates a PWM frequency of the PWM signal, wherein the PWM frequency is a multiple of the frequency of the output current.

6. The motor system according to claim 5, wherein the control module further comprises:
a voltage calculation module calculating a modulation duty cycle,
the modulation duty cycle represents a relationship between the input voltage and the DC bus voltage when the motor is in a boost or buck operation.

7. The motor system according to claim 6, wherein the control module further comprises:
a microcontroller adjusting a sampling frequency of the PWM signal based on the PWM frequency and a control signal from an external controller,
wherein the sampling frequency has a predetermined proportional value relative to the PWM frequency.

8. The motor system according to claim 1, wherein the power module comprises:
a modulation module, which is a DC bus modulation module that converts the input voltage into the DC bus voltage in response to the modulation signal.

9. The motor system according to claim 1, wherein the power module comprises:
a driver module generating the first-phase current, the second-phase current, and the third-phase current in response to the PWM signal and the DC bus voltage.

10. The motor system according to claim 1, wherein the power module comprises:
a voltage/current sensing module sensing the DC bus voltage and the output current to generate the corresponding feedback voltage value and the feedback current values.

11. A motor control method executed by a motor system, the motor system comprising:
generating by a power module of a motor driver a DC bus voltage and an output current based on an input voltage from the power supply;
generating by the power module a feedback voltage value corresponding to the DC bus voltage and a plurality of feedback current values corresponding to the output current, wherein the output current includes a first-phase current, a second-phase current, and a third-phase current;
rotating a motor by the output current, and generating a position signal associated with a rotational speed of the motor;
generating, by a control module of the motor driver, a modulation signal and a pulse width modulation (PWM) signal based on the feedback voltage value, the feedback current values, and the position signal; and
adjusting, by the power module, the first-phase current, the second-phase current, the third-phase current, and the DC bus voltage in response to the modulation signal and the PWM signal.

12. The motor control method according to claim 11, further comprising:
detecting, by a position sensor of the motor, a rotational mechanism of the motor to generate the position signal.

13. The motor control method according to claim 11, further comprising:
detecting, by a speed detection module of the control module, the rotational speed of the motor based on the position signal and determining whether the rotational speed has changed.

14. The motor control method according to claim 11, further comprising:
calculating, by a frequency calculation module of the control module, the frequency of the output current based on the rotational speed of the motor,
wherein the rotational speed is proportional to the frequency of the output current and inversely proportional to a pole number of the motor.

15. The motor control method according to claim 14, further comprising:
calculating, by the frequency calculation module, a PWM frequency of the PWM signal, wherein the PWM frequency is a multiple of the frequency of the output current.

16. The motor control method according to claim 15, further comprising:
calculating a modulation duty cycle by a voltage calculation module of the control module,
the modulation duty cycle represents a relationship between the input voltage and the DC bus voltage when the motor is in a boost or buck operation.

17. The motor control method according to claim 16, further comprising:
adjusting, by a microcontroller of the control module, a sampling frequency of the PWM signal based on the PWM frequency and a control signal from an external controller,
wherein the sampling frequency has a predetermined proportional value relative to the PWM frequency.

18. The motor control method according to claim 11, further comprising:
converting, by a modulation module of the power module, the input voltage into the DC bus voltage in response to the modulation signal, wherein the modulation module is a DC bus modulation module.

19. The motor control method according to claim 11, further comprising:
generating, by a driver module of the power module, the first-phase current, the second-phase current, and the third-phase current in response to the PWM signal and the DC bus voltage.

20. The motor control method according to claim 11, further comprising:
sensing, by a voltage/current sensing module of the power module, the DC bus voltage and the output current to generate the corresponding feedback voltage value and the feedback current values.
